(19) United States
(12) Patent Application Publication
(10) Pub. No.: US 2013/0285897 A1
(43) Pub. Date: Oct. 31, 2013

(54) FLAT DISPLAY SYSTEM AND OPERATION METHOD THEREOF

(71) Applicant: QUANTA COMPUTER INC., Tao Yuan Shien (TW)

(72) Inventor: Maw-Zan JAU, Taipei City (TW)

(73) Assignee: QUANTA COMPUTER INC., Tao Yuan Shien (TW)

(21) Appl. No.: 13/625,558

(22) Filed: Sep. 24, 2012

(30) Foreign Application Priority Data
Apr. 25, 2012 (TW) 101114719

(51) Int. Cl. G06F 3/01

(52) U.S. Cl. 345/156

(57) ABSTRACT

A flat display system includes a first flat device and a second flat device. The second flat device communicates with the first flat device via wireless communication. When the first flat device is located within a predetermined distance from the second flat device, the first flat device is transformed into an input device of the second flat device.

This application claims the benefit of Taiwan application Serial No. 101114719, filed Apr. 25, 2012, the subject matter of which is incorporated herein by reference.

### BACKGROUND

1. Technical Field

The disclosure relates to a flat display system and an operation method thereof.

2. Description of the Related Art

Accompanied with prosperities of technology, a penetration rate of flat device in the daily life ever grows and gradually renders a trend of replacing certain functions of conventional computers. Some users may at the same time own several flat devices. However, compared to a conventional laptop computer, a flat device lacks an additional input device, e.g., a physical keyboard. Thus, input convenience as well as input speed of the flat device are compromised such that flat device is incapable of fully replacing the laptop computer.

### SUMMARY OF THE DISCLOSURE

The disclosure is directed to a flat display system and an operation method thereof for optimizing user operation convenience.

According to an example of the disclosure, a flat display system including a first flat device and a second flat device is provided. The second flat device is connected with the first flat device via wireless communication. When the first flat device is located within a predetermined distance from the second flat device, the first flat device is transformed into an input device of the second flat device.

According to another example of the disclosure, an operation method of a flat display system is provided. The method includes the following steps. The first flat device and the second flat device are connected via wireless communication. When the first flat device is located within a predetermined distance from the second flat device, the first flat device is transformed into an input device of the second flat device.

The above and other contents of the disclosure will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of a flat display system according to one embodiment.

FIG. 2A is a partial flowchart of an operation method of a flat display system according to one embodiment.

FIG. 2B is another partial flowchart of an operation method of a flat display system according to one embodiment.

### DETAILED DESCRIPTION OF THE DISCLOSURE

In a flat display system and an operation method thereof, a flat device is transformed to an input device of another flat device to provide a similar input way of conventional computers, thereby optimizing user operation convenience.

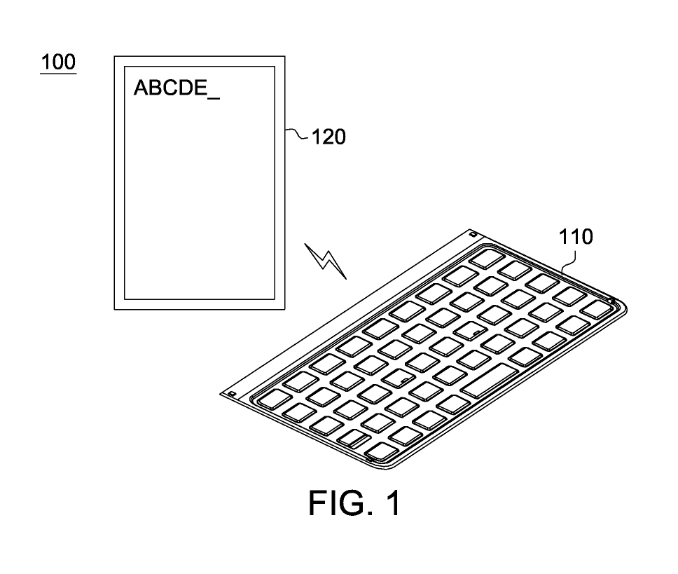

FIG. 1 shows a schematic diagram of a flat display system according to one embodiment. A flat display system 100 includes a first flat device 100 and a second flat device 120. The first flat device 110 connects to and communicates with the second flat device 120 via wireless communication. For example, the wireless communication includes Bluetooth, WiFi, wireless USB or Near Field Communication (NFC). When the first flat device 110 approaches the second flat device 120 within a predetermined distance, the first flat device 110 automatically transforms into an input device of the second flat device 120. For example, the predetermined distance is 20 cm, and the input device may be in a form of a virtual keyboard, a touch board or a hand-writing panel to provide input function.

In one embodiment, for example, the flat device is a monitor of a desktop computer, a laptop computer, a television, a mobile phone, a tablet computer, or an all-in-one computer. The flat devices listed above may be divided into two types—portable flat devices and non-portable flat devices. A portable flat device is defined as that a user can easily carry around, such as a laptop computer, a mobile phone and a tablet computer. In contrast, a non-portable flat device is a flat device that is rather immobile and cannot be readily carried around by a user, such as a desktop computer and a television.

In practice, the first flat device 110 and the second flat device 120 are both installed with an application program for detecting the type of the flat device to facilitate various settings. For example, when the first flat device 110 is a portable device such as a laptop computer, a tablet computer or a mobile phone, the application program sets a type parameter “portable” for identification purposes in the first flat device 110. When the second flat device 120 is a non-portable flat device such as a flat television or a monitor of a desktop computer, the application program sets another type parameter “non-portable” for identification purposes in the second flat device 120.

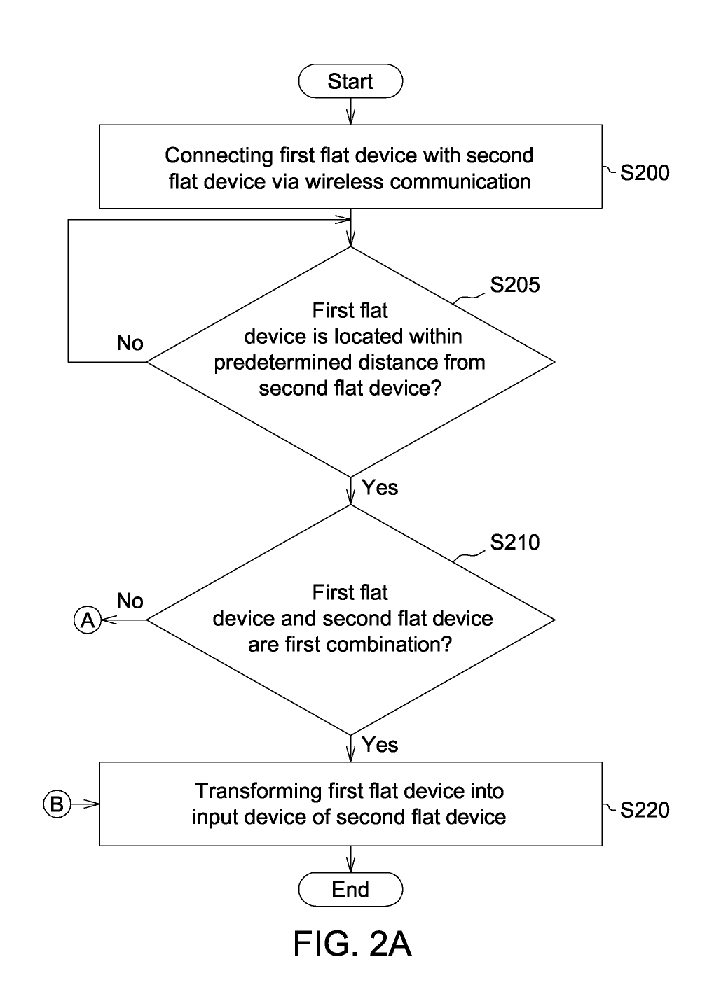

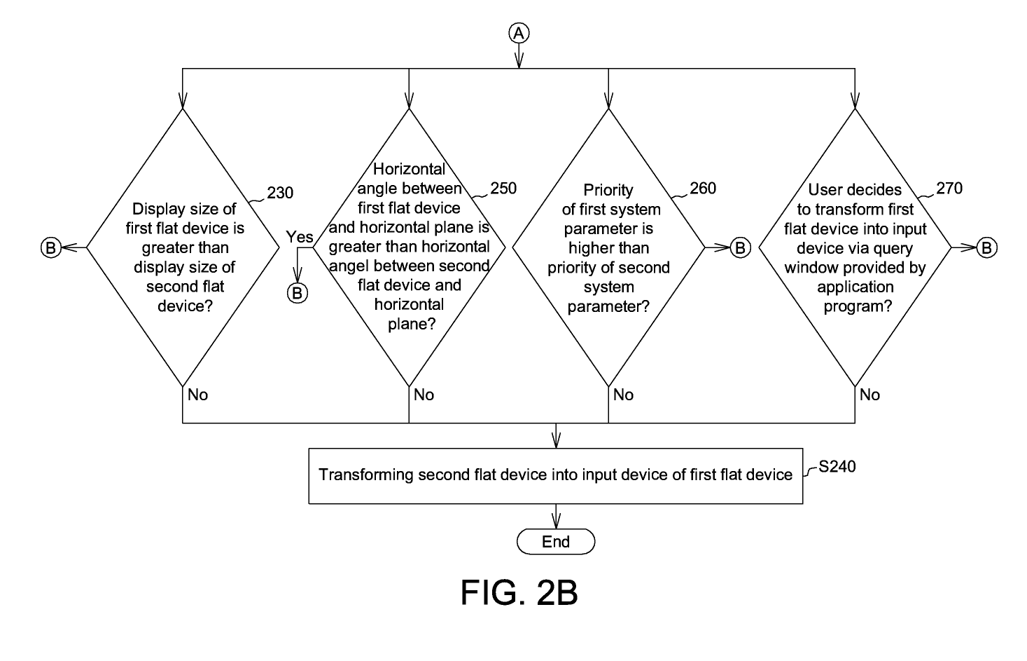

Based on the different types, the first flat device 110 and the second flat device 120 provide three combinations. A first combination is that either the first flat device 110 or the second flat device 120 is a portable flat device. A second combination is that both the first flat device 110 and the second flat device 120 are portable flat devices. A third combination is that both the first flat device 110 and the second flat device 120 are non-portable flat devices. It should be noted that the disclosure is targeted at transforming a flat device into an input device, and only the portable flat device but not the non-portable devices (e.g., a monitor of a desktop computer) are suitable for serving as input devices. Thus, if the application program detects that both the flat devices are non-portable flat devices, no operation is performed, i.e., a process in FIG. 2A is not initiated.

FIG. 2A shows a partial flowchart of an operation method of a flat display system according to one embodiment. In Step S200, the first flat device 110 and the second flat device 120 are connected via wireless communication. In Step S205, it is determined whether the first flat device 110 is located within a predetermined distance, such as 20 cm, from the second flat device 120. When a result of Step S205 is affirmative, Step S210 is performed to determine whether the combination of the first flat device 110 and the second flat device 120 are the first combination as previous described. For example, the second flat device 120 is a non-portable flat device and the first flat device 110 is a portable flat device. When a result of Step S210 is the first combination, Step S220 is performed to set the first flat device 110 being transformed into an input device of the second flat device 120 since a portable flat device is more suitable as an input device. It has to be noted that if the second flat device 120 is a portable flat device and the first flat device 110 is a non-portable flat device, the second flat device 120 is transformed into an input device of the first flat device 110 in Step S220.

FIG. 2B shows another partial flowchart of an operation method of a flat display system according to one embodiment. When the combination of the first flat device 110 and the second flat device 120 is not the first combination, it means the combination is the second combination. As previously described, the second combination means the first flat device 110 and the second flat device 120 are both portable flat devices. When the combination is the second combination, Step S230 is performed after Step S210. In Step S230, it is determined whether a display size of the first flat device 110 is greater than a display size of the second flat device 120. Due to the fact that a user would like to use the flat device having a greater size for performing inputting, thus if the size of the first flat device 110 is greater than the size of the second flat device 120, the process returns to Step S220 to transform the first flat device 110 into an input device of the second flat device 120. Conversely, when the size of the first flat device 110 is not greater than the size of the second flat device 120, the second flat device 120 is transformed into an input device of the first flat device 110 in Step S240.

Further, when the combination is the second combination, Step S250 may be performed after Step S210 to determine whether a horizontal angle (e.g., 15 degrees) between the first flat device 110 and a horizontal plane (e.g., a desk surface) is smaller than a horizontal angle (e.g., 60 degrees) between the second flat device 120 and the horizontal plane. It is assuming that the user would like to use a flat device with a smaller horizontal angle for performing inputting and use a flat device with a horizontal angle close to 90 degrees for displaying (e.g., similar to operate a convention desktop). Thus, when the horizontal angle of the first flat device 110 is smaller than that of the second flat device 120, the process returns to Step S220 to transform the first flat device 110 into an input device of the second flat device 120. Conversely, when the horizontal angle of the first flat device 110 is not smaller than that of the second flat device 120, the second flat device 120 is transformed into an input device of the first flat device 110 in Step S240.

Further, when the combination is the second combination, the application program may respectively build a first system parameter and a second system parameter in the first flat device 110 and the second flat device 120 to provide reference to determining a system priority. For example, to allow a flat device that is later installed with the application program to serve as an input device, the system parameter of the flat device that is later installed with the application program may be assigned with a higher priority. Thus, Step S260 may be performed after Step S210. In Step S260, it is determined whether the priority of the first system parameter built in the first flat device 110 is higher than that of the second system parameter built in the second flat device. When the priority of the first system parameter is higher than that of the second system parameter, the process returns to Step S220 to transform the first flat device 110 into an input device of the second flat device 120. Conversely, when the priority of the first system parameter is not higher than that of the second system parameter, Step S240 is performed to transform the second flat device 120 into an input device of the first flat device 110.

In one embodiment, the priorities of the system parameters are determined by a user during a process of installing the system parameters.

Further, when the combination is the second combination, a user is allowed to decide which of the flat devices the user would like to transform into an input device. Taking the user select the first flat device for example, after Step S210, Step S270 is performed in which the application program provides a query window for the user to decide whether to transform the first flat device 110 into an input device. When a result of Step S270 is affirmative, the process returns to Step S220 to transform the first flat device 110 into an input device of the second flat device 120. Conversely, Step S240 is performed to transform the second flat device 120 into an input device of the first flat device 110.

In this embodiment, the second combination is that both the first flat device 110 and the second flat device 120 are portable flat devices, and it is respectively determined which of the two flat devices is to be transformed into an input device in Steps S230 to S270. However, depending on actual requirements, Steps S230 to S270 may also be selectively performed. For example, when it is determined in Step S230 that the display sizes of the first flat device 110 and the second flat device 120 are equal, Step S250 is performed to compare the horizontal angles of the first flat device 110 and the second flat device 120. Alternatively, when Step S250 is first performed and it is determined that the horizontal angles of the first flat device 110 and the second flat device 120 are the same, Step S230 is performed to compare the display sizes of the first flat device 110 and the second flat device 120 to further determine which of the flat devices is to be transformed into an input device of the other.

In one embodiment, the third combination may be determined in Step S210. That is, the combination is determined as the third combination when the combination is not the first nor the second combination.

Alternatively, when the application program automatically detects that neither of the flat devices is a portable flat device, it is determined that the combination is the third combination. Thus, no further action is taken, e.g., neither of the flat devices is transformed into an input device.

Further, to fulfill the requirements of the foregoing flat display system and the operation method thereof, it is necessary that the portable devices in the embodiments be equipped with a processor (for executing the application program), a storage device (for storing the system parameters), a wireless communication module, a touch panel (for serving as an input device) and an angle sensor (for detecting the horizontal angles). Moreover, it is necessary that the non-portable devices be equipped with a processor, a storage device and a wireless communication module, and optionally be provided with a touch panel and an angle sensor.

With the embodiments, it is illustrated that in the flat display system and the operation method thereof, by installing the application program, when two flat devices are located from each other within a predetermined distance, one flat device of the two flat devices can be transformed into an input device of the other flat device to provide a fast input method similar to that in a conventional computer, thereby optimizing user operation convenience.

While the disclosure has been described by way of example and in terms of the preferred embodiments, it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A flat display system, comprising:
a first flat device; and
a second flat device, connected with the first flat device via wireless communication;
wherein, when the first flat device is located within a predetermined distance from the second flat device, the first device is transformed into an input device of the second flat device.

2. The flat display system according to claim 1, wherein the second flat device is a non-portable flat device and the first flat device is a portable flat device.

3. The flat display system according to claim 1, wherein the first flat device and the second flat device are portable flat devices.

4. The flat display system according to claim 3, wherein a size of the first flat device is greater than a size of the second flat device.

5. The flat display system according to claim 4, wherein an angle between the first flat device and a horizontal plane is smaller than an angle between the second flat device and the horizontal plane.

6. An operation method for a flat display device, comprising:
connecting a first flat device with a second flat device via wireless communication; and
transforming the first flat device into an input device of the second flat device when the first flat device is located within a predetermined distance from the second flat device.

7. The operation method according to claim 6, wherein the second flat device is a non-portable flat device and the first flat device is a portable flat device.

8. The operation method according to claim 6, wherein the first flat device and the second flat device are portable flat devices.

9. The operation method according to claim 8, wherein a size of the first flat device is greater than a size of the second flat device.

10. The operation method according to claim 8, wherein an angle between the first flat device and a horizontal plane is smaller than an angle between the second flat device and the horizontal plane.
